(19) United States
(12) Patent Application Publication
(10) Pub. No.: US 2014/0154455 A1
(43) Pub. Date: Jun. 5, 2014

(54) COMPONENT FOR A VEHICLE

(71) Applicants: Andreas Eppinger, Bergisch Gladbach (DE); Daniel Jendritza, Krefeld (DE); Ming Huo, Windsor (CA); Wei Lange-Mao, Hagen (DE); Yanning Zhao, Burscheid (DE)

(72) Inventors: Andreas Eppinger, Bergisch Gladbach (DE); Daniel Jendritza, Krefeld (DE); Ming Huo, Windsor (CA); Wei Lange-Mao, Hagen (DE); Yanning Zhao, Burscheid (DE)

(73) Assignee: Johnson Controls GmbH

(21) Appl. No.: 14/003,768

(22) PCT Filed: Jan. 24, 2012
(86) PCT No.: PCT/EP2012/051040

§ 371 Date: Dec. 16, 2013

(30) Foreign Application Priority Data
Mar. 7, 2011 (DE) 10 2011 013 227.9

(51) Int. Cl. H01F 1/42

(52) U.S. Cl. CPC H01F 1/42
USPC 428/71; 252/62.54; 252/62; 428/192; 428/137; 428/76

(57) ABSTRACT

A component for a vehicle, includes at least one component part, which is made of a magnetically active foam material and/or a foam material which can be magnetically activated and/or a dielectric elastomer. The component is at least partially or completely laterally delimited so that the component elastically expandable in at least one degree of freedom. The component can be a switch element, a transducer, an active muffler, and/or an energy conversion element.

The invention relates to a component for a vehicle. The invention also relates to a use for a component for a vehicle.

Electronic, mechanical and/or electromechanical components for vehicles, such as for example a switch, sound transducer, sound damping element, energy converter or measuring instruments, are usually produced from plastic.

The prior art discloses components for vehicles that are magnetic or magnetically activatable and elastically deformable.

In this respect, DE 10 2007 022 403 A1 discloses a permanent magnet which comprises a main body with a north magnetic pole and a south magnetic pole, the main body being elastically deformable. For this purpose, the main body is for example produced from a foam material. The permanent magnet is used as a pressure sensor, for example in motor vehicles for seat occupancy detection, for the issuing of alarm signals, as a switching element for operating air-conditioning systems, etc.

It is also known to use magnetorestrictive elements for the specific movement of components or vibrational damping of components.

The object of the present invention is to provide a component for a vehicle that is improved in comparison with the prior art and in particular has a high degree of stiffness and a low weight and also a long service life.

The object is achieved according to the invention by a component that has the features specified in claim 1.

According to the invention, a component for a vehicle has at least one component part, which is formed from a magnetically active and or magnetically activatable foam material and/or a dielectric elastomer, the component part being laterally delimited at least partially or completely in such a way that the component part is elastically expandable with at least one degree of freedom.

The delimitation of the component part advantageously makes the degree of freedom or degrees of freedom of the expansion of the component part predeterminable, so that an expansion-induced change in a magnetic field or in an electromagnetic pressure is controllable. The expansion of the component part takes place on the basis of an external effect, which is preferably mechanical and/or electrical.

On account of the use of a magnetically active and/or magnetically activatable foam material, the component part has a high degree of stiffness, low density, good energy absorption, increased mechanical damping, good sound insulation, good thermal and electrical conductivity and also optimum shielding from electromagnetic fields. Also when dielectric elastomers are used, a relatively light weight, a long service life and also good energy absorption of the component part are achieved. Preferably, a reduction in the susceptibility to wear of the component parts, and consequently of the component, is possible by means of the use of a magnetically active and/or magnetically activatable foam material or a dielectric elastomer.

In a first preferred embodiment of the invention, the component part is delimited by a frame. The frame is preferably formed from a mechanically stable material, for example a mixture of plastic and ceramic.

In a second preferred embodiment of the invention, the component part is delimited by at least one adjacent further component. In this way, an expansion of the component part can be realized cost-efficiently, since not only the delimitation of the component part but also further applications can be realized by means of the further component.

For an optimum delimitation of the component part, the adjacent, further component lies against the component part with positive and/or non-positive engagement.

In a third preferred embodiment of the invention, the component part is delimited by means of being arranged in a wall of an opening. The wall of the opening determines an opening, which is for example part of the vehicle, so that a delimitation of the component part is possible in a space-saving and cost-efficient manner.

In a fourth preferred embodiment of the invention, the component part is delimited by means of being encapsulated in a further material, the further material having a corresponding strength. The further material is preferably connected to the component part by a material bond, so that an optimum delimitation of the component part can be realized.

According to the invention, a use of the component described above provides that the component part is used as a switching element and/or sound transducer and/or active sound damping element and/or energy conversion element.

The component is suitable for example as a switching element for operating an air-conditioning system, a window-lifting system or seat heating of a vehicle or for controlling the volume of an entertainment medium in a vehicle.

As a sound transducer, the component may for example be integrated in a sound system of the vehicle.

As an active sound damping element, acoustic energy in a space, in particular a passenger compartment, can be advantageously reduced by means of the component. For example, it is possible in this way to eliminate to the greatest extent vibrations that disturb vehicle occupants, for example vibrations of vehicle windows and/or backrests, during the operation of the vehicle.

In addition, the component can be integrated as an energy conversion system in a hydraulic system, by means of which amplitudes or forces can be amplified or by means of which linear influences can be coupled into rotary generators.

The invention is explained in more detail on the basis of the accompanying figures, in which:

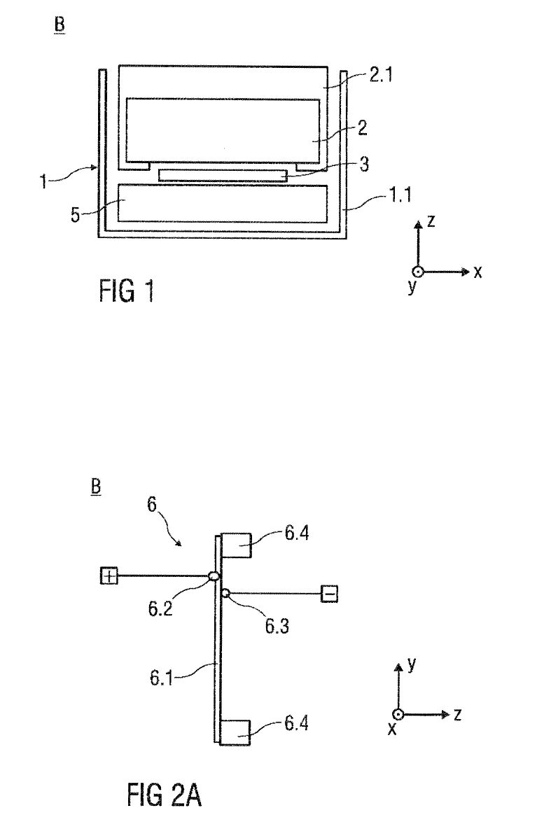

FIG. 1 schematically shows a sectional representation of a switching element,

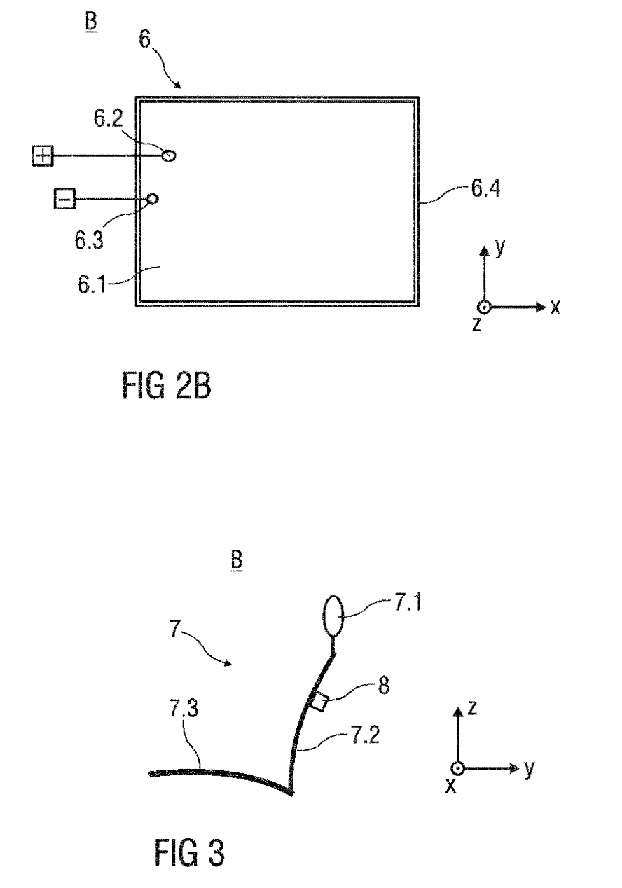

FIG. 2A schematically shows a side view of a sound transducer,

FIG. 2B schematically shows the sound transducer according to FIG. 2A in plan view,

FIG. 3 schematically shows a side view of a vehicle seat with an active sound damping element and

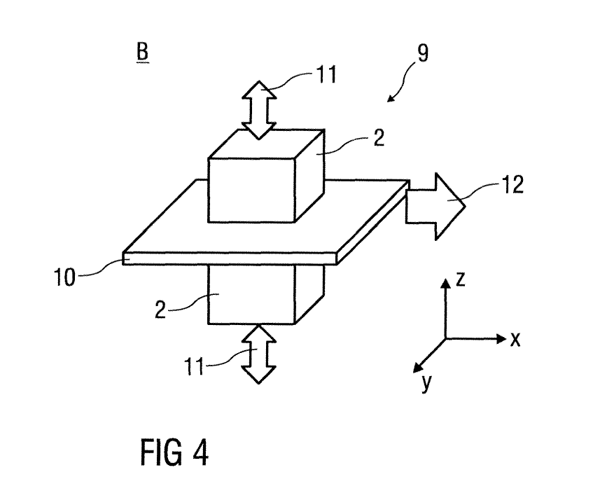

FIG. 4 schematically shows a device for energy conversion in a perspective view.

Parts corresponding to one another are provided with the same reference signs in all of the figures.

FIG. 1 shows a sectional representation of a component B, which is formed as a switching element 1 and is arranged in a mount 1.1.

The switching element 1 is for example a button and is used for controlling instruments with high precision.

For example, the switching element 1 may be used for controlling an air-conditioning system, a window-lifting system or seat heating of a vehicle or for controlling the volume of an entertainment medium in a vehicle.

The switching element 1 comprises an element 2, which is formed from a magnetically active and/or magnetically activatable and compressible foam material with a magnetically activatable surface 2.1. The element 2 is referred to hereinafter as a magnetic foam block 2.

The use of a magnetic foam block 2 is particularly advantageous, since foam materials have very good reversible deformation properties. The foam material is formed for example from styrene butadiene rubber or ethyl vinyl acetate and has any desired pore sizes.

Magnetic particles are arranged in the foam material, the arrangement preferably being homogeneous. The magnetic particles are preferably ferromagnetic particles, for example strontium ferrite particles, and have a particle diameter in the lower micrometer range, 0.1-10 micrometers, so that the foam material is not significantly influenced in its structure.

The magnetically activatable surface 2.1 has an increased concentration of ferromagnetic particles in comparison with the magnetic foam block 2.

An expansion of the magnetic foam block 2 in the transverse alignment x is limited by means of the mount 1.1, which for this purpose is preferably formed from a material of a corresponding strength.

The magnetic foam block 2 has a magnetic field, the field strength of which can be changed for example by an external, mechanical pressure effect on the magnetically activatable surface 2.1. The magnitude of the magnetic field strength can be sensed by means of a sensor 3 arranged in the switching element 1.

With respect to a longitudinal alignment y of the switching element 1, represented by an arrow, the sensor 3 is arranged underneath the magnetic foam block 2.

The change in the field strength of the magnetic field sensed by the sensor 3 is passed on in the form of an electrical signal to a control device that is not represented of an instrument to be controlled, which evaluates the electrical signal correspondingly.

In addition, the electrical signal is passed on to an actuator unit 5, which is arranged downstream from the sensor 3 in the vertical alignment z of the switching element 1.

In dependence on the electrical signal, the actuator unit 5 generates, for example by means of a coil, a vibration, which can be sensed on a haptic and/or tactile basis. For example, a user of the instrument receives feedback that the actuation of the switching element 1 has been sensed.

The switching element 1 consequently makes it possible for the instrument that is intended to be controlled to be controlled quickly and has a long service life, since material deformations are avoided to the greatest extent on account of the material properties of the magnetic foam block 2.

Furthermore, the use of the magnetic foam block 2 makes it possible for the switching element 1 to be used in a large temperature range, for example from −40 degrees Celsius to +85 degrees Celsius.

In addition, external disturbances, disturbances caused by the switching element 1, possible influencing of the electromagnetic compatibility and also influences of other magnetic materials in the instrument as well as influencing of the switching element 1 caused by atmospheric humidity are counteracted.

FIGS. 2A and 2B show the component B, which is formed as a sound transducer 6, the sound transducer 6 being represented in side view in FIG. 2A and in plan view in FIG. 2B.

The sound transducer 6 has a dielectric elastomer 6.1, which is preferably pre-expanded and is formed as a compliant, electrostatic capacitor. For example, the dielectric elastomer consists of silicone or acrylic. Dielectric elastomers are also distinguished by a low weight and a high elastic energy density.

Furthermore, the dielectric elastomer 6.1 is arranged between two expandable electrodes 6.2, 6.3, in particular between a positive electrode 6.2 and a negative electrode 6.3, and is completely surrounded by a frame 6.4.

The sound converter 6 may be used for example as a sound system (overhead-integrated sound system). For this purpose, the electrodes 6.2, 6.3 are electrically connected to an audio amplifier unit that is not represented.

If a voltage is applied to the electrodes 6.2, 6.3, they attract one another on account of the electrostatic pressure occurring. As a result, the dielectric elastomer 6.1 is compressed in its volume and expands laterally, whereby an electromagnetic pressure is generated. In the present exemplary embodiment, an expansion of the dielectric elastomer 6.1 in the vertical alignment z of the sound transducer 6 is limited. In an alternative embodiment, an expansion of the dielectric elastomer 6.1 is also possible in the transverse alignment x or longitudinal alignment y of the sound transducer 6, for which purpose the frame 6.4 has to be arranged correspondingly.

Continuous changing of the applied voltage has the effect that the electromagnetic pressure generated by the dielectric elastomer 6.1 changes in proportion to the voltage. The continuous changing of the electromagnetic pressure results in a vibration of the dielectric elastomer 6.1.

In order to generate the greatest possible frequency range of the vibrations to be generated, the dielectric elastomer 6.1 may be formed from a material with differing volumes.

Alternatively, it is also possible to produce a dielectric elastomer 6.1 with a smaller volume, which makes it possible for very small voltages to be applied.

In order to counteract thermal influences and/or influences of atmospheric humidity on the sound transducer 6, the dielectric elastomer 6.1 may be provided with a corresponding coating.

In addition, the influencing of the dielectric elastomer 6.1 caused by external interference signals may be counteracted by means of an electrically shielding element, which is arranged on the dielectric elastomer 6.1.

By means of the dielectric elastomer 6.1 it is possible to use a sound transducer 6 that is formed flat to the greatest extent, since it is not necessary to install integrated vibration generators.

Furthermore, on account of its high energy density, low costs and versatility, the sound transducer 6 offers a large number of applications for new technologies. For example, the sound transducer 6 can be used in haptic feedback devices, pumps, artificial muscles, valves or loudspeakers.

FIG. 3 schematically shows a side view of a vehicle seat 7 with the component B, which is formed as an active sound damping element 8.

The vehicle seat 7 comprises a head restraint 7.1, a backrest 7.2 and a seat part 7.3.

The active sound damping element 8 comprises a magnetic foam block 2, which forms both a sensor 3 and an actuator unit 5.

The magnetic foam block 2 is induced by a mechanical vibration, in particular a sound, to oscillate, whereby a corresponding mechanical counter oscillation is generated, so that, by means of destructive interference, a resultant amplitude of the mechanical oscillation and counter oscillation, i.e. the acoustic energy in a space, is reduced. An expansion of the active sound damping element 8 is limited on account of the arrangement in or on the backrest 7.2 of the vehicle seat 7, in particular in the longitudinal alignment y of the active sound damping element 8. Alternatively or in addition, an expansion of the active sound damping element 8 may also be limited in the vertical alignment z or transverse alignment x, for example by the magnetic foam block 2 being encapsulated in another material that has a corresponding strength.

It is consequently possible to eliminate to the greatest extent vibrations that are disturbing for vehicle occupants, for example of vehicle windows and/or backrests 7.2, during operation of the vehicle.

In addition, such an active sound damping element 8 has a high energy efficiency.

FIG. 4 shows the component B, which is formed as a device 9 for energy conversion and comprises two cuboidal magnetic foam blocks 2 and an output element 10 formed as a plate for the output of electrical signals.

The magnetic foam blocks 2 are in this case arranged in relation to one another respectively opposite a planar side of the output element 10, an expansion of the magnetic foam blocks 2 in the vertical alignment z of the device 9 being limited by the output element 10.

The magnetic foam blocks 2 are compressed by external effects 11, respectively represented as a double-sided arrow, such as for example mechanical pressure.

The compression of the magnetic foam blocks 2 brings about a movement of the electrical charges in the magnetic field of the magnetic foam blocks 2. Since the external effects act perpendicularly in relation to the magnetic field of the magnetic foam blocks 2, the Lorentz force acts on the moved electrical charges of the magnetic foam blocks 2 and thus sets them in motion. This charge transfer brings about a potential difference and generates an electrical voltage 12, represented by a double-sided arrow, which is output by means of the output element 10, for example to an electric motor that is not represented.

Depending on the application, the output of the electrical voltage 12 may be either amplified or damped by means of further components.

The magnetic foam blocks 2 act in the device 9 as active elements and make it possible, on account of their already described good material properties, to convert kinetic energy into electrical energy in a simple and low-cost way.

In addition, it is possible to extend the device 9. For example, a hydraulic system by means of which amplitudes of forces can be amplified or coupled into rotary generators by means of linear influences may be integrated in the device 9.

Further application examples of magnetic foam blocks 2 that are not represented any more specifically are discussed below.

In order to generate a signal that can be sensed on a haptic basis, it is possible to use magnetic foam blocks 2 in combination with coils, as already described in FIG. 1.

For this purpose, at least one magnetic foam block 2 and at least one coil are arranged for example in seat foam cushions, door trims, instrument panels and/or roof linings of a vehicle.

The magnetic foam block 2 is compressed by means of external pressure effects, whereby the field strength of the magnetic field of the magnetic foam block 2 is changed. As a result, a vibration with a corresponding frequency is generated by the coil flowed through by current and can be sensed on a haptic basis.

For example, the magnetic foam block 2 may be used in the seat part 7.3 and/or in the backrest 7.2 of the vehicle for massaging a vehicle occupant.

In this way it is possible, by controlling the magnetic field of the magnetic foam blocks 2, to generate vibrations with different amplitudes and frequencies for the haptic sensing of a signal, for example a warning signal.

The use of magnetic foam blocks 2 for generating a signal that can be sensed on a haptic basis has the advantage over the use of electroactive polymers that significantly lower voltages are required, preferably in the range of 12 Volts.

In addition, the use of magnetic foam blocks 2 for generating signals that can be sensed on a haptic basis makes it possible to reduce weight and additional component parts in comparison with the generation of signals that can be sensed on a haptic basis from the prior art.

A further application example is the use of magnetic foam blocks 2 in a head restraint 7.1 of a vehicle seat 7 for reducing injuries during a vehicle collision.

In this case it is possible by means of the controllable field strength of the magnetic foam block 2 to reduce a distance between the head of the vehicle occupant and the head restraint 7.1, so that a risk of injury to the head of the vehicle occupant caused by a vehicle collision is reduced.

It is consequently possible to use an active head restraint 7.1 with a low weight and few components for the protection of vehicle occupants in a vehicle.

In addition, applications of magnetic foam blocks 2 in man-machine interfaces with force feedback or for sensor localization are possible.

### LIST OF REFERENCE SIGNS

1 switching element
1.1 mount
2 element, magnetic foam block
2.1 magnetically activatable surface
3 sensor
5 actuator unit
6 sound transducer
6.1 dielectric elastomer
6.2 positive electrode
6.3 negative electrode
6.4 frame
7 vehicle seat
7.1 head restraint
7.2 backrest
7.3 seat part
8 active sound damping element
9 device
10 output element
11 external effects
12 electrical voltage
B component
x transverse alignment
y longitudinal alignment
z vertical alignment

1. A component for a vehicle, comprising:
at least one component part, which is formed from a magnetically active and/or magnetically activatable foam material and/or a dielectric elastomer, the component part being laterally delimited at least partially or completely in such a way that the component part is elastically expandable with at least one degree of freedom.

2. The component as claimed in claim 1, wherein the component part is delimited by a frame.

3. The component as claimed in claim 1, wherein the component part is delimited by at least one adjacent further component.

4. The component as claimed in claim 3, wherein at least one adjacent further component lies against the component part with positive and non-positive engagement.

5. The component as claimed in claim 1, wherein the component part is delimited by being arranged in a wall of an opening.

6. The component as claimed in claim 1, wherein the component part is delimited by being encapsulated in a further material, the further material having a corresponding strength.

7. The component as claimed in claim 1, wherein the component is at least one of a switching element, a sound transducer, an active sound damping element, and an energy conversion element.
